(19) United States
(12) Patent Application Publication
(10) Pub. No.: US 2009/0241572 A1
(43) Pub. Date: Oct. 1, 2009

(54) Low Energy Consumption Air Conditioning System

(76) Inventors: Lionel Nicolai, Vitrolles (FR); Alain Nicolai, Allauch (FR); Robert Castro, Marseille (FR); Marc Lassus, Marseille (FR)

Correspondence Address: JAMES C. LYDON, 100 DAINGERFIELD ROAD, SUITE 100, ALEXANDRIA, VA, 22314, US

(21) Appl. No.: 12/083,775

(22) PCT Filed: Oct. 18, 2005
(86) PCT No.: PCT/FR2005/002575

§ 371 Date: Apr. 18, 2008

(51) Int. Cl. F25B 19/00; F25D 27/00; F25D 3/00; F28D 5/00; G05D 23/00; G05D 22/02; A62C 37/10

(52) U.S. Cl. 62/231; 62/264; 62/318; 62/314; 236/51; 236/44 A; 169/60

(57) ABSTRACT

An air-conditioning system including a water inlet, a processing module having a particle filter (20) for trapping particles larger than about 4.5 μm, an anti-colloid filter for trapping colloid substances larger than about 1.2 μm, an ultra-filtration filter for trapping micro-organisms larger than 0.1 μm and an UVC lamp for destroying micro-organisms smaller than 0.1 μm, and at least one air-conditioning apparatus (14, 16, 18) for receiving water filtered by the processing module, where the air-conditioning apparatus includes an electrovalve (38), a high-pressure pump (40), at least one misting rail (42), a fan (44) for a misting operation in a room during pump operation, and a control housing (46) for opening the electrovalve and for switching on the pump and the fan for predetermined operation time intervals separated by predetermined temporization periods.

### TECHNICAL FIELD

The present invention pertains to the air-conditioning of living or office premises and essentially relates to a very low power-consumption air-conditioning device.

### PRIOR ART

The air-conditioning systems currently available on the market are based on the refrigeration generated by the compression cycles of a refrigerant gas. The calories required for a good operation of the cooling apparatus (also called air-conditioning device) are supplied from the room to be air-conditioned and in which the temperature decreases accordingly.

It is clear that the air-conditioning technology as we know it today has a very high power consumption. Experts have calculated that if only 30% of the French households were to be equipped with air-conditioning systems in their housings, France should build 10 additional nuclear power plants just to meet this power demand.

Furthermore, it is a well-known fact that the refrigerant gases used for air-conditioning are harmful for the ozone layer. As all air-conditioning apparatuses, including the most sophisticated ones, eventually release a portion of the gas they contain, they contribute to the destruction of the ozone layer that protects the Earth from ultraviolet radiation.

### DISCLOSURE OF THE INVENTION

One objective of the invention is to provide an air-conditioning system that has a very low power consumption as compared with current air-conditioning systems.

Another objective of the invention is to provide an air-conditioning system that do not release destructive gases into the ozone layer.

Accordingly, the invention relates to an air-conditioning system for the air-conditioning of one or more rooms or closed passenger compartments, that comprises a water inlet, a processing module for receiving the water from the water inlet and successively comprising a particle filter for trapping particles having a size higher than about 4.5 μm, an anti-colloid filter for trapping colloid substances having a size higher than about 1.2 μm, an ultra-filtration filter for trapping micro-organisms having a size higher than 0.1 μm, and an UVC lamp for destroying micro-organisms having a size lower than 0.1 μm, as well as an air-conditioning apparatus for receiving the water filtered by the processing module. The air-conditioning apparatus includes an electrovalve, a high-pressure pump, at least one misting rail and a fan for a misting operation in a room during the operation of the pump, and a control housing for opening the electrovalve and for switching on the pump and the fan for predetermined operation time intervals separated by predetermined temporisation periods.

### BRIEF DESCRIPTION OF THE DRAWINGS

The purposes, objects and characteristics of the invention will be better understood from the following description and by reference to the drawings in which:

FIG. 1 is a schematic diagram of the air-conditioning system according to one preferred embodiment of the invention;

FIG. 2 is a schematic diagram of the air-conditioning apparatus used in the air-conditioning system of FIG. 1; and

FIG. 3 is a variation of the air-conditioning apparatus of FIG. 2 also used for detecting a fire start.

### DETAILED DESCRIPTION OF THE INVENTION

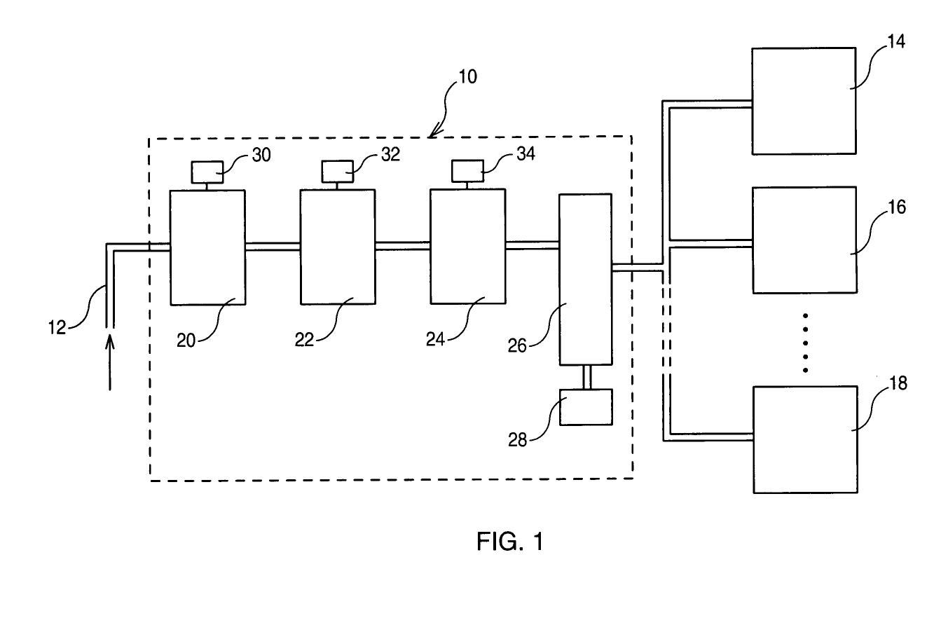

Referring to FIG. 1, the air-conditioning system of the invention includes a processing module 10 for receiving water to be processed from a water inlet 12, 1 to 20 air-conditioning apparatuses 14, 16, 18 each provided in housing premises, in an office or in any other room to be air-conditioned.

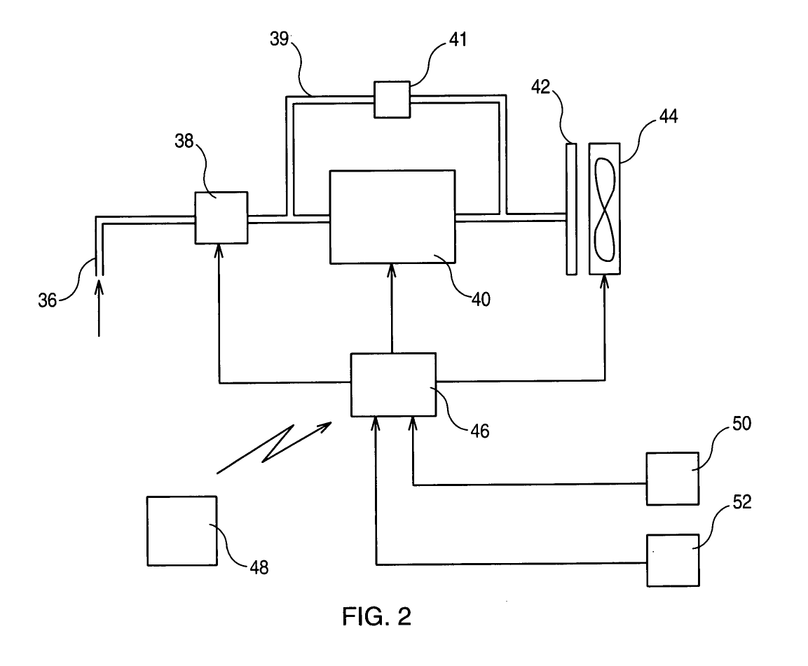

The processing module 10 successively includes a particle filter 20 for trapping particles having a size higher than about 4.5 μm, an anti-colloid filter 22 for trapping colloid substances having a size higher than about 1.2 μm, an ultra-filtration filter 24 for trapping micro-organisms having a size higher than 0.1 μm, and an UVC lamp for destroying micro-organisms having a size lower than 0.1 μm. It should be noted that the filters 20, 22, 24 are respectively provided with pressure gauges 28, 30, 32 for monitoring filter clogging. Each air-conditioning apparatus shown in FIG. 2 includes, downstream from the water inlet 36 of the processing module 10, an electrovalve 38, a high-pressure pump 40, at least one misting rail 42 and a fan 44 adjacent to the misting rail 42. During the operation of the pump, the water from the water inlet 12 (see FIG. 1) is filtered by the processing module 10, flows through the electrovalve 38 and the pump 40 and is eventually misted in the misting rail 42, the water droplets from the nozzles of the misting rail being projected into the room by the fan 44.

It should be noted that the pump 40 does not use all the water from the water inlet 36 and that, in order to prevent the unused excess water from flowing out of the pump due to the pressure, a bypass duct 39 with a check valve 41 thereon is preferably used for connecting the inlet and the outlet of the pump.

A control housing 46 provided on the air-conditioning apparatus is electrically connected to the electrovalve 38, the pump 40, and the fan 44. When operated, the control housing controls the opening of the electrovalve 38 and the activation of the pump 40 and the fan 44.

The control housing 46 is also used for activating a misting temporisation automaton so that the activation of the control takes place during a predetermined operation time interval followed by a predetermined temporisation interval, e.g. a 2-second operation duration followed by a 20-second temporisation.

According to the preferred embodiment, the control housing is operated through an infrared radiation remote control. Besides the control for operating the control housing, the remote control further comprises a TEMP key for varying the ratio between the operation time interval and the temporisation interval. It is thus possible to select among three modes, i.e. Min, Medium, Max, the Medium mode being automatically selected when the user depresses the ON key.
Min: operation during 1 second and temporisation during 20 seconds;
Medium: operation during 2 seconds and temporisation during 20 seconds;
Max: operation during 3 seconds and temporisation during 20 seconds.

It should be noted that the remote control may further includes other control keys such as a key for varying the speed of the fan between two positions.

According to a preferred embodiment, a thermostat 50 and a humidity sensor 52 are provided in the room where the air-conditioning apparatus is used. The thermostat 50 and/or the humidity sensor 52 are integrated into the control housing or are connected to the control housing via a wired connection or an infrared link. The thermostat 50 is manually adjusted by the user at a desired temperature (e.g. 22° C.) and deactivates the control housing when the room temperature becomes equal to or lower than said temperature.

Similarly, the humidity sensor 52 is manually adjusted by the user in order to have a predetermined humidity content in the room. When the humidity content of the room becomes higher than or equal to said value, a deactivation signal is sent to the control housing 46.

The air-conditioning system described above can be used for the air-conditioning of a 40 m² surface by an air-conditioning apparatus while taking into account a temperature decrease of between 6° C. and 12° C. The power savings are substantial since a traditional air-conditioning device having a 1 kW power is required for a 25 m² room, while the power required for system of the invention is only 0.07 kW, i.e. a power consumption lower by 93%.

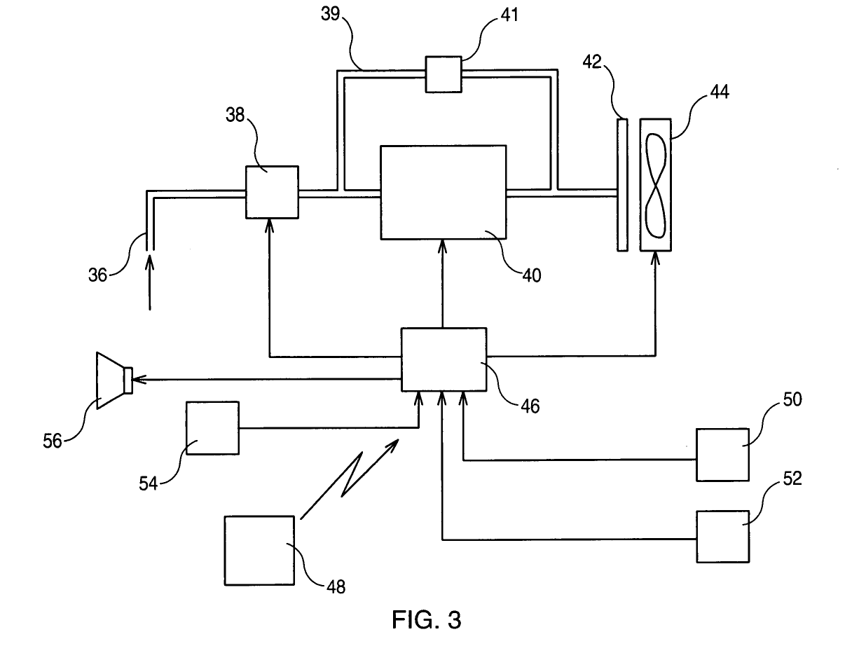

According to a variation of the invention shown in FIG. 3, the air-conditioning system can also be used as an extinguishing device in case of a fire in a room. To this end, the system further includes one or more fire start sensors, such as sensor 54, provided at appropriate locations in the room. The sensor 54 is connected to the control housing 46 and transmits a signal thereto when detecting smoke or when the temperature of the room reaches a predetermined value, e.g. 45° C. The signal switches the control housing into a fire-start detection mode. The housing sends an alarm signal to a sound alarm 56 and controls the continuous operation of the misting rail 42 without actuating the fan 44 in order to prevent any air draft. Two situations may occur. If the air-conditioning system is operating the operation of the pump 40 is modified so that it operates continuously without taking any temporisation into account while the operation of the fan 44 is interrupted. In case the system is not in operation, the housing controls the opening of the electrovalve 38 and the pump 40 is turned on regardless of any temporisation, and an alarm signal is transmitted to the sound alarm 56. It should be noted that the air-conditioning system may include a limited group of misting rails (e.g. one rail) that are actuated for air-conditioning purposes only while all ramps are actuated in case a fire start is detected.

The air-conditioning system of the invention can also be used in the passenger compartment of a vehicle such as an automobile vehicle or an aircraft. In this case, the processing module may be omitted and the water source supplying water to the water inlet 36 is a water tank attached to the vehicle.

### DRAWINGS

FIG. 1
12 Water inlet
20 Particle filter
30, 32, 28 Pressure gauge
22 Anti-colloid filter
24 Ultra-filtration filter
10 Processing module
26 UVC lamp
14, 16, 18 Air-conditioning apparatus

FIG. 2
36 Water inlet
38 Electrovalve
39 Bypass duct
41 Check valve
42 Misting rail
40 Pump
44 Fan
46 Control housing
48 Remote control
50 Thermostat
52 Humidity sensor

FIG. 3
36 Water inlet
38 Electrovalve
39 Bypass duct
41 Check valve
42 Misting rail
40 Pump
44 Fan
46 Control housing
48 Remote control
50 Thermostat
52 Humidity sensor
54 Fire-start sensor

1-10. (canceled)

11. An air-conditioning system for the air-conditioning of one or more rooms or closed passenger compartments, comprising
a water inlet,
a processing module for receiving the water from the water inlet and successively comprising a particle filter for trapping particles having a size higher than about 4.5 μm, an anti-colloid filter for trapping colloid substances having a size higher than about 1.2 μm, an ultra-filtration filter for trapping micro-organisms having a size higher than 0.1 μm, and an UVC lamp for destroying micro-organisms having a size smaller than 0.1 μm,
and at least one air-conditioning apparatus for receiving the water filtered by the processing module, wherein said air-conditioning apparatus includes an electrovalve, a high-pressure pump, at least one misting rail for a misting operation in a room during the operation of the pump, and a control housing for opening the electrovalve and for switching on said pump and said fan for predetermined operation time intervals separated by predetermined temporisation periods.

12. The air-conditioning system of claim 11, wherein said predetermined operation time interval ranges from 1 to 3 seconds and said predetermined temporisation period is equal to 20 seconds.

13. The air-conditioning system of claim 10, further comprising a remote control for remote operation of the control housing by a user.

14. The air-conditioning system of claim 13, wherein said remote control further includes a key that can be actuated for selecting the duration of the predetermined operation time interval between 1, 2 and 3 seconds.

15. The air-conditioning system of claim 10, further comprising a thermostat connected to said control housing by a wired or infrared connection so that the user can adjust the temperature of the room at a desired temperature, said thermostat transmitting a deactivation signal to said control housing when the room temperature becomes equal to or lower than said desired temperature.

16. The air-conditioning system of claim 15, further comprising a humidity sensor connected to said control housing by a wired or infrared connection so that the user can adjust the humidity content of the room at a desired value, said humidity sensor transmitting a deactivation signal to said control housing when the humidity content of the room becomes equal to or higher than said desired value.

17. The air-conditioning system of claim 10, wherein said particle filter, anti-colloid filter and ultra-filtration filter are respectively provided with pressure gauges in order to monitor clogging thereof.

18. The air-conditioning system of claim 10, wherein a bypass duct having a check valve mounted thereon is provided for connecting the inlet and the outlet of said pump in order to prevent the unused excess water from flowing out of the pump.

19. The air-conditioning system of claim 10, further comprising at least one fire-start sensor for transmitting a signal to said control housing when detecting smoke or when the temperature of the room reaches a predetermined value, said control housing then controlling the continuous opening of said pump.

20. The air-conditioning system of claim 19, further comprising a limited group of misting rails that are actuated for air-conditioning purposes while all ramps are actuated in case a fire start is detected.
